(19) United States
(12) Patent Application Publication
(10) Pub. No.: US 2008/0141360 A1
(43) Pub. Date: Jun. 12, 2008

(54) Wireless Linked Computer Communications

(75) Inventors: Richard Hicks, Malvern (GB); Richard Anthony Case, Malvern (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 11/666,805

(22) PCT Filed: Oct. 21, 2005
(86) PCT No.: PCT/GB05/04057

§ 371 Date: May 1, 2007

(30) Foreign Application Priority Data
Nov. 3, 2004 (GB) 0424292.1
Dec. 7, 2004 (GB) 0426774.6

(51) Int. Cl. G06F 21/00

(52) U.S. Cl. 726/15

(57) ABSTRACT

Computer communications with security marked information use a wireless link between a receiving network (RN) and a computer (WLT1) each running VPN wire-link security software and wireless-link security software. A physical LAN in the network (RN) is subdivided into logical management and communications LANs. The management LAN manages a switch (L3S), access point (AP), RADIUS server (RS) and Certificate server (CS). The access point (AP) is managed only by management LAN items. The switch (L3S) ensures message traffic from management LAN ports goes only to other such ports; it and the access point (AP) are managed only by the RADIUS server via SSH. The access point (AP) contacts the RADIUS server (RS) to authenticate user certificates and receives SSH traffic only. The management LAN is synchronized to an NTP server. The communications LAN allows an authenticated computer (WLT1) to communicate with a classified WAN (N1). Message traffic does not go to the RADIUS server (RS) or Certificate server (CS).

This invention relates to computer communications, and to a method, an apparatus and computer software for implementing them. More particularly, it relates to computer communications involving information which may have security marking.

Methods of connecting laptop computers to fixed computer networks by wireless links (radio or optical links) are well-known in the prior art, and are defined by standards referred to as the IEEE 802.11 standards: these standards are specifications for radio-based digital Local Area Networks (LANs); WPA (Wi-Fi Protected Access) is an interoperability certification standard which provides security for wireless products based on the IEEE 802.11i standard; and Wi-Fi (Wireless Fidelity) is a body which certifies products for compliance with IEEE 802.11 standards.

The standards referred to include the following:
IEEE; Wireless LAN Medium Access Control, (MAC), and Physical Layer, (PHY), Specifications, IEEE Standard 802.11—1999. IEEE; High-speed Physical Layer in the 5-GHz Band, IEEE Standard 802.11a—1999. IEEE; Higher-speed Physical Layer in the 2.4 GHz Band, IEEE Standard 802.11b—1999. IEEE; Further Higher-Speed Physical Layer Extension in the 2.4 GHz Band, IEEE Standard 802.11g—2003.
IEEE; Specification for Enhanced Security, IEEE draft work in progress Standard 802.11i—2003.
Wi-Fi Alliance; Wi-Fi Protected Access (WPA) Specification, latest version.

Products are commercially available from more than one company for securely connecting computers to remote networks via wired telephone links available in the conventional way by dialling a number. Here “wired” includes wired communications paths such as via the public switched telephone network (PSTN, which may include radiated microwave path sections) used by public telecommunications operators (PTOs). These products can reasonably be accredited as suitable for use in passing UK classified information. A list of such products is available from the Communication Electronics Security Group (CESG), the UK Government's National Technical Authority for Communications.

A manufacturer of wireless equipment may apply to have it tested by CESG and accredited as suitable for use with classified information, in a similar manner to that implemented for wired links. However, accreditation is a time-consuming process and requires the manufacturer to freeze the wireless equipment design. CESG only approves a specific design: an approved design which is altered in any way, such as by fixing a bug, automatically becomes non-approved.

An alternative accreditation route is provided by a document published by CESG and known as Manual V. Equipment in conformity with principles set out in Manual V should obtain CESG approval. However, although Manual V specifies some requirements, it intentionally does not go into detail to leave room for equipment design flexibility.

It is an object of the invention to provide an alternative technique for wireless communications.

The present invention provides a method for computer communications having the steps of:
a) establishing a wireless link between computer apparatus and a receiving network implementing two protocols at least one of which is for encrypting messages, one protocol being a virtual private network (VPN) protocol suitable for securing wire-linked communications and the other protocol being a wireless-linking protocol of a kind suitable for securing wireless-linked communications;
b) applying both protocols to a message to render it doubly secured;
c) sending the doubly secured message over the wireless link; and
d) processing the doubly secured message to recover the message.

The invention makes it possible to use a range of existing wired access techniques to provide access in a wireless scenario. Moreover, if accredited wired access has been obtained, it becomes possible to re-use such access for wireless applications without the need for new techniques or infrastructure or staff retraining.

The step of applying both protocols may comprise applying the VPN protocol to a message to render it VPN-secured and applying the wireless-linking protocol to the VPN-secured message to render it doubly secured.

The receiving network may have a logical LAN configuration protecting it against unauthorised access. The logical LAN configuration may have first and second logical LANs, the first logical LAN:
a) having elements which cannot be remotely managed except by at least one other element of that LAN,
b) having ports from which message traffic is constrained to go only to other ports on that LAN, and
c) implementing a wireless authentication process and secure communication within that LAN; and
   the second logical LAN is arranged to enable the computer apparatus when authenticated to communicate with a classified network or an unclassified network, and has firewall functionality configured to avoid message traffic to and from the computer apparatus affecting the first logical LAN.

The first logical LAN may include:
a) an access point for communication with wireless-linked computer apparatus;
b) a switch to constrain message traffic from first logical LAN ports to go only to other first logical LAN ports; and
c) a RADIUS server for implementation of the wireless-linking protocol which provides an authentication process.

The first logical LAN may be associated with firewall functionality configured to monitor data flow within and to and from that LAN but excluded from management of elements of that LAN.

The wireless-linking protocol may involve certificate-based authentication and be implemented by means of a RADIUS server. It may alternatively be implemented by means of a pre-shared key (PSK). It may involve authentication by EAP-TLS, EAP-TTLS, PEAP or LEAP as hereinafter defined.

The step of applying both protocols may involve producing secured status by encryption to provide a VPN-encrypted message and to provide for the doubly secured message to be doubly encrypted, and the step of processing the doubly secured message to recover the message then involves double decryption.

The receiving network may have classified and unclassified virtual networks and the method may include allowing the doubly secured message access to the classified virtual network, and also allowing wireless messages access to the unclassified virtual network if such messages are secured by the wireless-linking protocol but not the VPN protocol. It may be associated with offline and root certificate servers and the method may include authenticating wireless messages using certificates from such servers. It may have an unclassified RADIUS server and the method may include authenticating wireless messages using certificates from that server. It may have an unclassified certificate server arranged to supply certificates marked to indicate use by wireless only and the method may include authenticating messages by wireless using certificates so marked from that server.

The method may include counteracting a security threat posed by potential computer theft by arranging for the computer apparatus to be screen locked when it becomes unattended by authorised personnel.

In another aspect, the present invention provides an apparatus for computer communications incorporating:
a) means for establishing a wireless link between computer apparatus and a receiving network implementing two protocols at least one of which is for encrypting messages, one protocol being a VPN protocol suitable for securing wire-linked communications and the other, protocol being a wireless-linking protocol of a kind suitable for securing wireless-linked communications;
b) means for applying both protocols to a message to render it doubly secured;
c) means for sending the doubly secured message over the wireless link; and
d) means for processing the doubly secured message to recover the message.

The means for applying both protocols may be arranged to apply the VPN protocol to a message to render it VPN-secured and to apply the wireless-linking protocol to the VPN-secured message to render it doubly secured.

The receiving network may have a logical LAN configuration protecting it against unauthorised access. The logical LAN configuration may have first and second logical LANs; the first logical LAN:
a) having elements which cannot be remotely managed except by at least one other element of that LAN,
b) having ports from which message traffic is constrained to go only to other ports on that LAN, and
c) implementing a wireless authentication process and secure communication within that LAN; and
   the second logical LAN is arranged to enable the computer apparatus when authenticated to communicate with a classified network or an unclassified network, and has firewall functionality configured to avoid message traffic to and from the computer apparatus affecting the first logical LAN.

The first logical LAN may include:
d) an access point for communication with wireless-linked computer apparatus;
e) a switch to constrain message traffic from first logical LAN ports to go only to other first logical LAN ports; and
f) a RADIUS server for implementation of the wireless-linking protocol which provides an authentication process.

The first logical LAN may be associated with firewall functionality configured to monitor data flow within and to and from that LAN but excluded from management of elements of that LAN.

The apparatus may include means for implementing a RADIUS server arranged to provide the wireless-linking protocol in a form which involves certificate-based authentication. It may alternatively include means for implementing a pre-shared key (PSK) to provide the wireless-linking protocol. As a further alternative, it may include means for providing the wireless-linking protocol using authentication by ESP-TLS, EAP-TTLS, PEAP or LEAP.

The means for applying both protocols may be arranged to produce secured status by encryption to provide a VPN-encrypted message and to provide for the doubly secured message to be doubly encrypted, and the means for processing the doubly secured message to recover the message is then arranged to provide double decryption.

The receiving network may have classified and unclassified virtual networks and the apparatus may be arranged to allow the doubly secured message access to the classified virtual network and also to allow wireless messages access to the unclassified virtual network if such messages are secured by the wireless-linking protocol but not the VPN protocol. It may be associated with offline and root certificate servers and the apparatus may be arranged to authenticate wireless messages using certificates from such servers. It may have an unclassified RADIUS server and the apparatus may be arranged to authenticate wireless messages using certificates from that server. It may have an unclassified certificate server arranged to supply certificates marked to indicate use by wireless only and the apparatus may be arranged to authenticate messages by wireless using certificates so marked from that server.

The apparatus may be arranged to counteract a security threat posed by potential computer theft by providing for the computer apparatus to become screen locked when unattended by authorised personnel.

In a further aspect, the present invention provides computer software for computer communications, the software having instructions for controlling a computerised communications network to execute the steps of:
a) establishing a wireless link between computer apparatus and a receiving network implementing two protocols at least one of which is for encrypting messages, one protocol being a VPN protocol suitable for securing wire-linked communications and the other protocol being a wireless-linking protocol of a kind suitable for securing wireless-linked communications;
b) applying both protocols to a message to render it doubly secured;
c) sending the doubly secured message over the wireless link; and
d) processing the doubly secured message to recover the message.

The software may have instructions for implementing application of both protocols by applying, the VPN protocol to a message to render it VPN-secured and applying the wireless-linking protocol to the VPN-secured message to render it doubly secured.

The software may have instructions for implementing a logical LAN configuration protecting the receiving network against unauthorised access. The logical LAN configuration may have first and second logical LANs; the first logical LAN:
d) having elements which cannot be remotely managed except by at least one other element of that LAN,
e) having ports from which message traffic is constrained to go only to other ports on that LAN, and
f) implementing a wireless authentication process and secure communication within that LAN; and
   the second logical LAN is arranged to enable the computer apparatus when authenticated to communicate with a classified network or an unclassified network, and has firewall functionality configured to avoid message traffic to and from the computer apparatus affecting the first logical LAN.

The first logical LAN may include:
g) an access point for communication with wireless-linked computer apparatus;
h) a switch to constrain message traffic from first logical LAN ports to go only to other first logical LAN ports; and
i) a RADIUS server for implementation of the wireless-linking protocol which provides an authentication process.

The first logical LAN may be associated with firewall functionality configured to monitor data flow within and to and from that LAN but excluded from management of elements of that LAN.

The software may have instructions for implementing a RADIUS server to provide the wireless-linking protocol, which may involve certificate-based authentication. It may alternatively have instructions for implementing a pre-shared key (PSK) to provide the wireless-linking protocol. As a further alternative, it may include instructions for implementing the wireless-linking protocol with authentication by EAP-TLS, EAP-TTLS, PEAP or LEAP.

The software may have instructions for applying both protocols to produce secured status by encryption to provide a VPN-encrypted message and to provide for the doubly secured message to be doubly encrypted, and for processing the doubly secured message to recover the message by double decryption.

The receiving network may have classified and unclassified virtual networks and the software may have instructions for allowing the doubly secured message access to the classified virtual network and for allowing wireless messages access to the unclassified virtual network if they are secured by the wireless-linking protocol but not the VPN protocol. It may be associated with offline and root certificate servers and the software may have instructions for authenticating wireless messages using certificates from such servers. The software may have instructions for authenticating wireless messages using certificates from an unclassified RADIUS server which the receiving network incorporates. The receiving network may have an unclassified certificate server arranged to supply certificates marked to indicate use by wireless only, and the software may have instructions for authenticating messages by wireless using certificates so marked from that server.

The software may include instructions for counteracting a security threat posed by potential computer theft by providing for the computer apparatus to be screen locked when it becomes unattended by authorised personnel.

In order that the invention might be more fully understood, embodiments thereof will now be described, by way of example only, with reference to the accompanying drawings, in which:

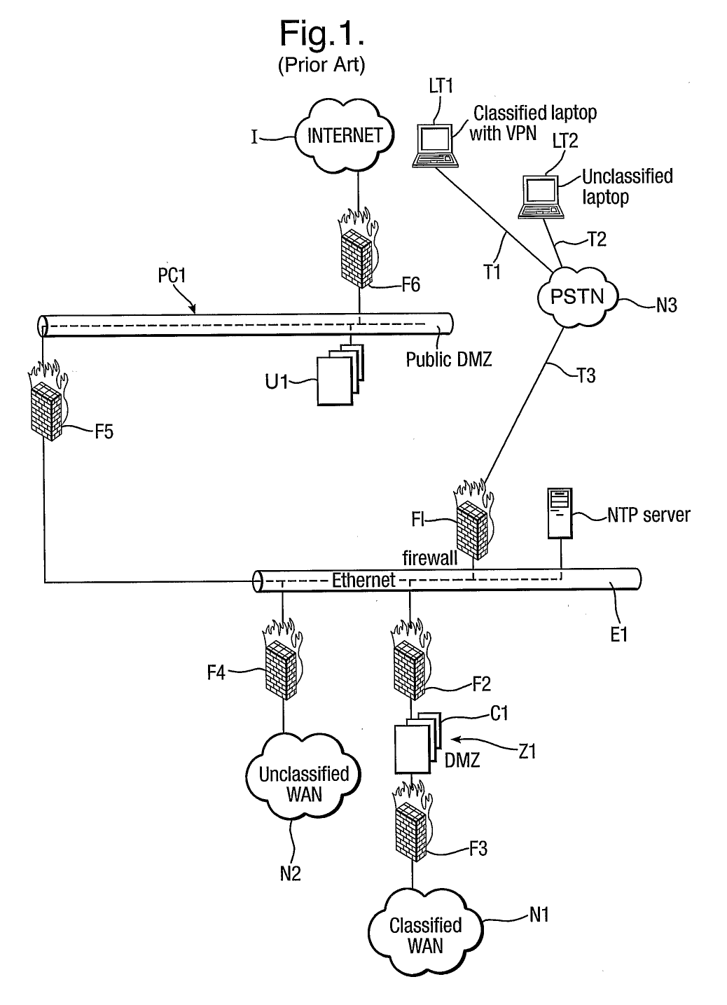

FIG. 1 is a schematic diagram illustrating prior art computer communications over a wired network;

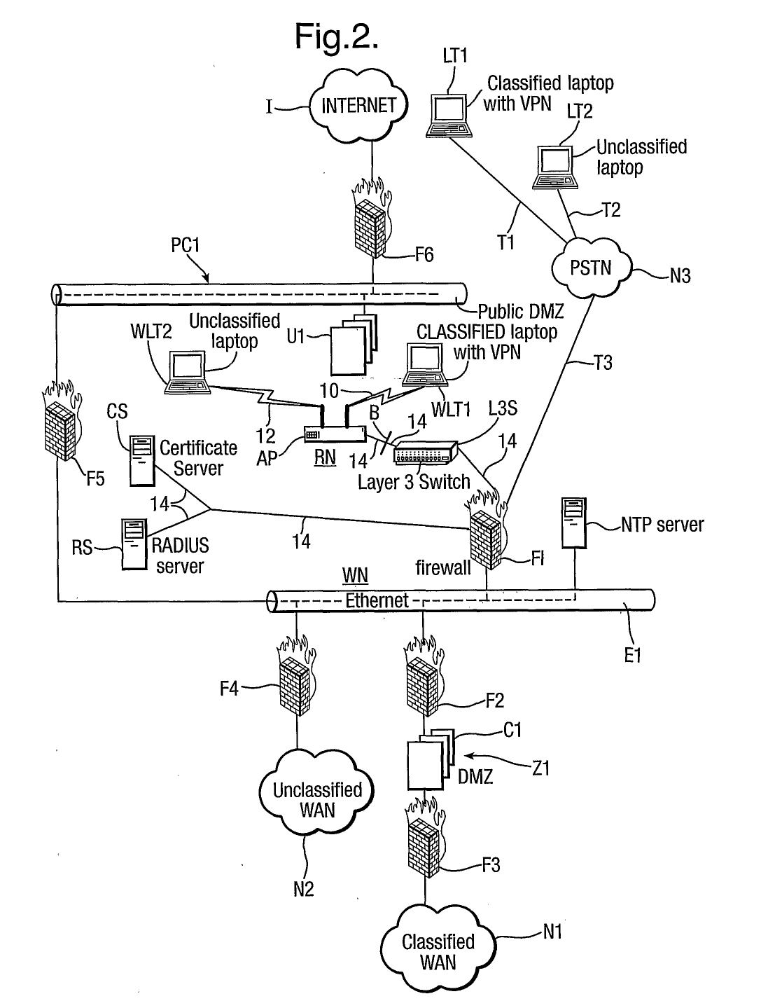

FIG. 2 is a version of FIG. 1 with modifications to include computer communications by wireless links in accordance with the invention;

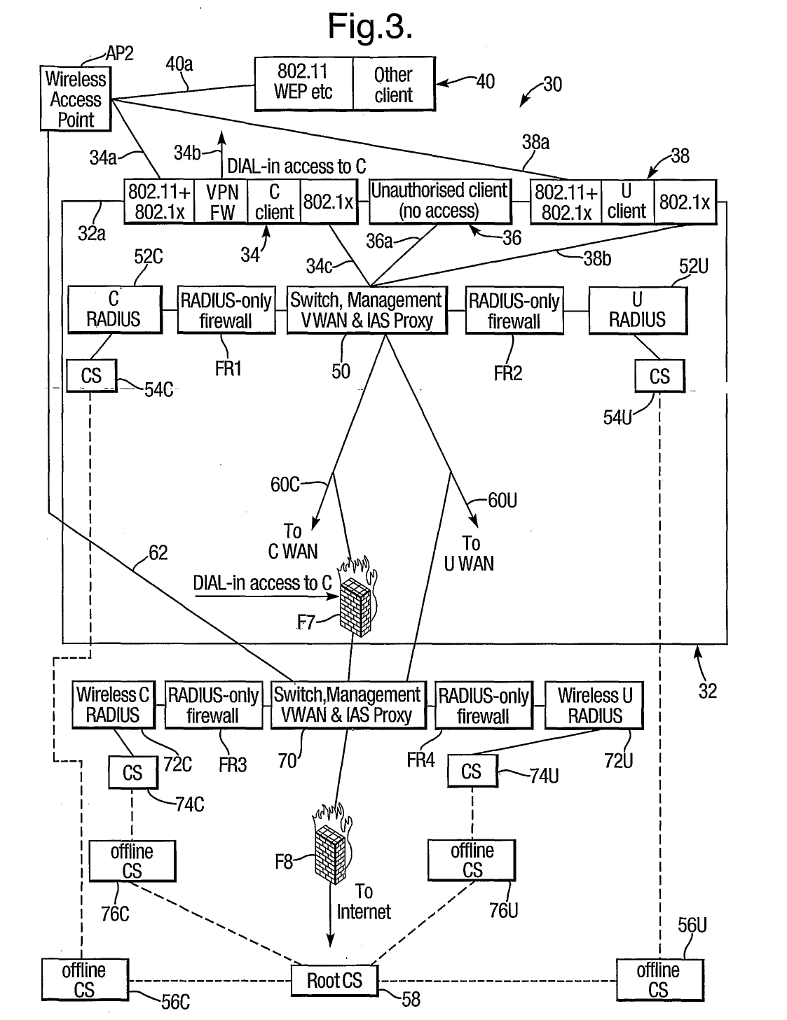

FIG. 3 is an embodiment of the invention is shown for use in connection with a prior art wired network employing virtual WANs;

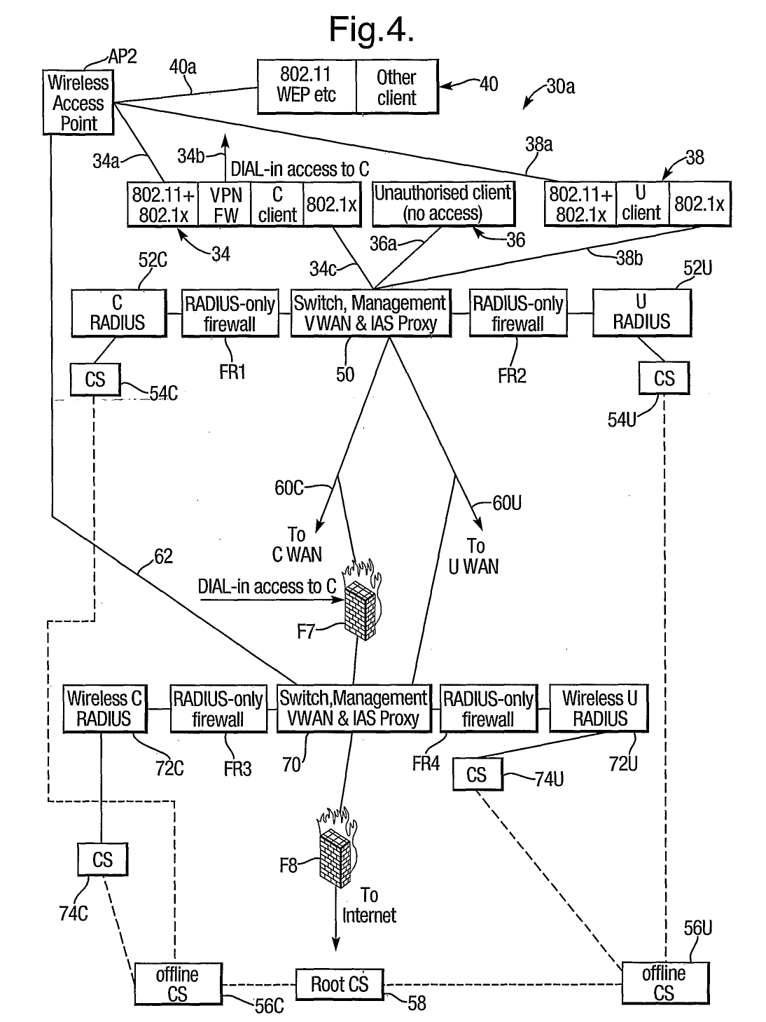

FIG. 4 is a modified version of the FIG. 3 embodiment to remove offline certificate servers from the wireless network;

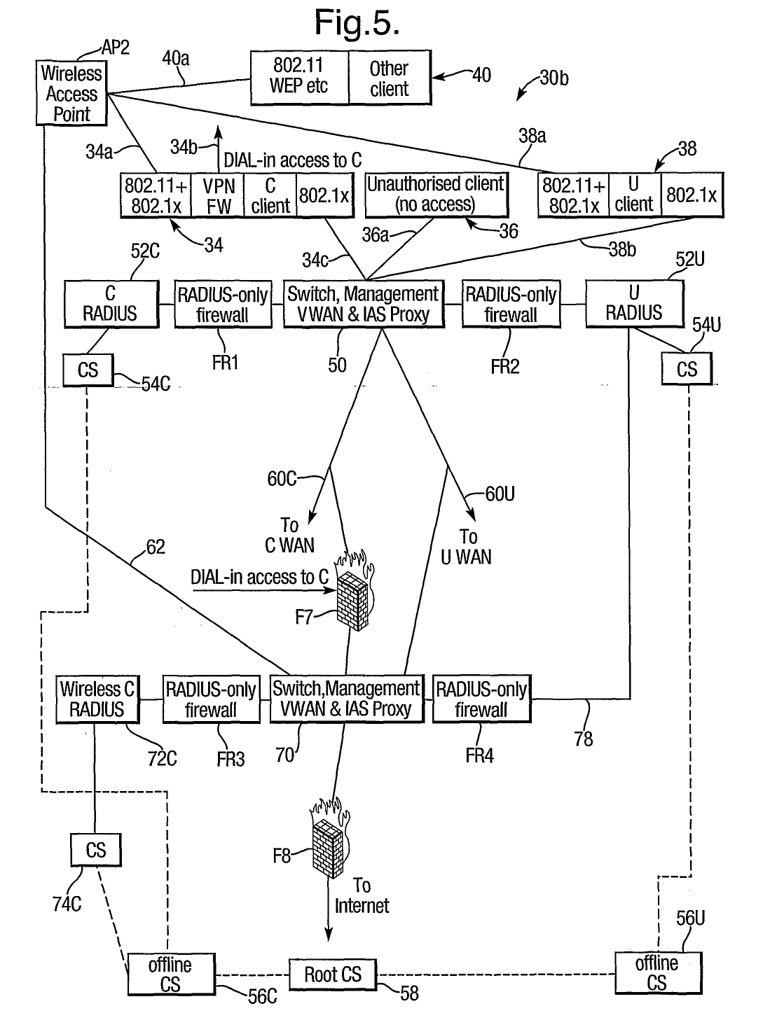

FIG. 5 is a modified version of the FIG. 4 embodiment to dispense with unclassified certification items in the wireless network; and

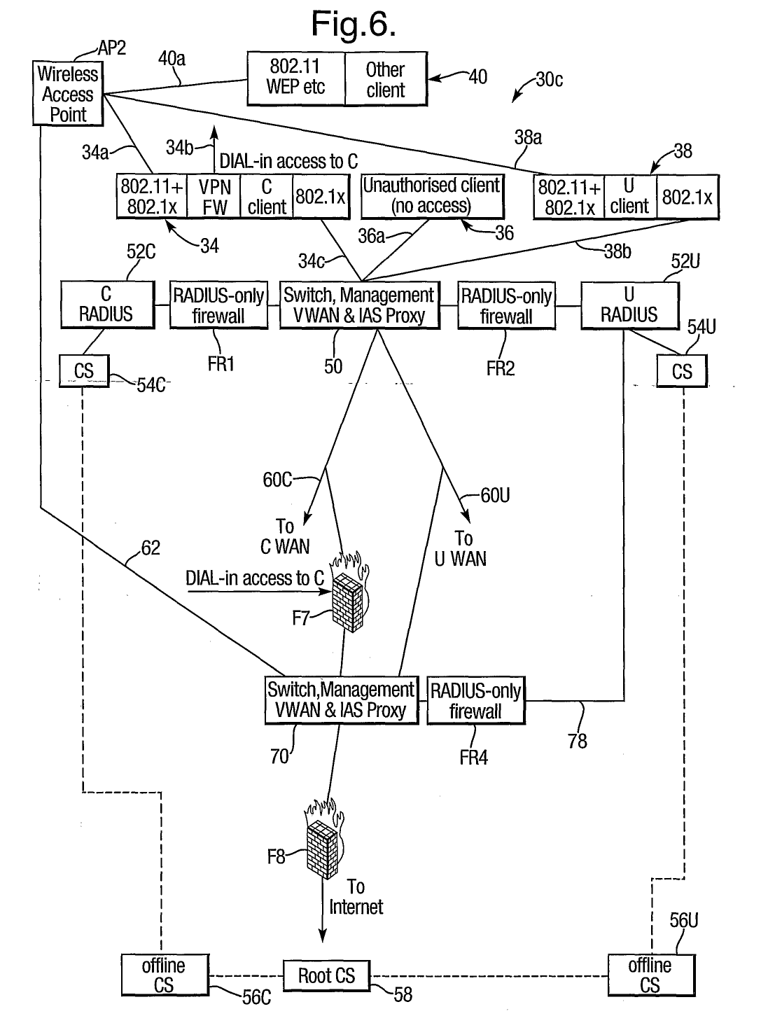

FIG. 6 is a modified version of the FIG. 5 embodiment to dispense with classified certification items in the wireless network

Referring to FIG. 1, a prior art communications system is shown for connecting laptop computers (laptops) LT1 and LT2 to first and second remote wide area networks (WANs) N1 and N2 via respective dial-up wired telephone links T1 and T2 connected to a public switched telephone network (PSTN) N3. The PSTN N3 is connected to a first remote firewall F1 by a wired link T3. The laptop LT2 is referred to as being “Unclassified” since it contains no classified data. As such, it does not have any security protection suitable for classified data. The laptop LT1 is designated “Classified” because it is suitable for classified data: this is because it runs a certificate-based virtual private network (VPN) software product, such as that sold by Check Point Software Technologies Ltd (www.checkpoint.com). This VPN is based on the Internet Protocol Security (IPSec) standards:
IPsec Standards, IETF RFCs 2401 to 2411

In practice the term VPN could be used to cover any networking technology which offers a level of security to the networking traffic that uses it. For example, HTTPS (secure web sites such as Internet Banking), SSH (secure shell—defined below), IPSec (the most suitable to be termed a pure VPN technology), PPP (Point-to-Point Protocol), GPRS (General Packet Radio Service used on mobile telephones), 3G (3^{rd} Generation of mobile telephone technology), WPA (Wi-Fi Protected Access used in wireless networks) and Bluetooth (used for short range, low bandwidth wireless links) all offer some level of security to the traffic they carry.

However, for clarity of this document the term VPN will only cover technologies not specifically designed for wireless links. For example, the term VPN includes HTTPS, SSH, IPSec and PPP but exclude GPRS, 3G, WPA and Bluetooth.

The Check Point VPN software is approved by CESG as suitable for use in passing classified information to remote recipients via wired communications links. It is configured to use “secure tunnelling” through the wired links T1, T3 and E1. The expression “secure tunnelling” arises as follows: a computer adds a protocol P1 (e.g. IP Internet Protocol) to message data D. The VPN software encrypts the protocol combination P1D and adds a second protocol P2 (e.g. IPSec ESP Encapsulating Security Payload) which merely shows the message has been encrypted. A third protocol P3 (e.g. IP) is required to render the protocol combination P2P1D suitable for onward transmission to Firewall F1, Ethernet E1 and Firewall F2, and so it is added by the computer. Firewall F2 then removes Protocols P3 and P2, and decrypts the protocol combination P1D. This is then suitable for onward transmission through DMZ Z1 to a recipient or recipients. Upon receipt the first protocol P1 will be removed and the data D consumed. The first protocol combination P1D is said to tunnel through the third protocol P3.

Data from the PSTN N3 which is allowed to pass by the first firewall F1 reaches an Ethernet LAN E1, to which the first WAN N1 is connected via a second firewall F2, a first demilitarised zone (DMZ) Z1 and a third firewall F3. The first DMZ Z1 contains computers such as C1 for use by system administrators only. The second and third firewalls F2 and F3 are of different types, so unwanted communications which manage to breach the first and second firewalls F1 and F2 are unlikely to breach the third firewall F3. This arrangement is conventional for provision of a high level of security for a network intended to be suitable for dealing with classified data, and hence the first WAN N1 is designated a “classified” network.

When the classified laptop LT1 requests a VPN tunnel communication (defined above) with the classified WAN N1 via the PSTN N3, the first firewall F1 passes the request to the second firewall F2 The two parties LT1 and F2 are then able to negotiate authentication and encryption protection for transfer of classified data. The negotiation occurs using a secure message exchange in which the second firewall F2 attempts to validate credentials stored on the classified laptop LT1. This may also occur in the opposite direction, with the classified laptop LT1 validating credentials stored on the second firewall F2. If the validation is successful, keys derived from the message exchange are then used for VPN encryption between the classified laptop LT1 and the second firewall F2. This procedure creates a path or tunnel from the classified laptop LT1 to the second firewall F2: the path is unclassified from the classified laptop LT1 as far as the second firewall F2, and classified from the classified laptop LT1 to the DMZ Z1.

The second WAN N2 is connected to the Ethernet LAN E1 via a single firewall, i.e. a fourth firewall F4: it is designated an “unclassified” network because the first and fourth firewalls F1 and F4 only provide a moderate level of security for communications from the unclassified laptop LT2. A network time protocol (NTP) server provides time synchronisation for all devices communicating with the Ethernet LAN E1, which is connected via a fifth firewall F5 to a public communications medium PC1 providing a public DMZ. User computers such as U1 are connected to the public communications medium PC1, and communicate with the Internet I via a sixth firewall F6. This sixth firewall F6 provides a low level of security for the public DMZ, which is tolerated in the interests of allowing many types of communications traffic to pass between the public DMZ and the Internet, e.g. email and web browsing. It allows browsing from the Internet I to the public DMZ, but the fifth firewall F5 inhibits browsing from the Internet I to the Ethernet LAN E1.

For the purposes of the description below, the following terms of art will be used:
RADIUS (Remote Authentication Dial-In User Service): a communications protocol primarily used to authenticate users to a network by a variety of methods; and
SSH (Secure Shell): a communications protocol that can provide secure sessions for certain network traffic. It is most commonly used to provide secure terminal access, similar to Telnet.

In addition, a variety of prior art computer-based user authentication techniques may be used in the following example, a number of which are described in the following references:
IEEE; Port Based Network Access Control, IEEE Standard 802.1x, September 2001.
Congdon, P., Aboba, B., Smith, A., Zorn, G. and J. Roese, “IEEE 802.1x Remote Authentication Dial In User Service (RADIUS) Usage Guidelines”, IETF RFC 3580, September 2003.
Rigney, Willens, Rubens, Simpson; Remote Authentication Dial In User Service (RADIUS), IETF RFC 2865, June 2000.
Rigney, Willats, Calhoun; RADIUS Extensions, IETF RFC 2869, June 2000.
Aboba, B. and P. Calhoun, “RADIUS (Remote Authentication Dial In User Service) Support For Extensible Authentication Protocol (EAP)”, IETF RFC 3579, September 2003.
Aboba, et al.; Extensible Authentication Protocol (EAP), IETF RFC 3748, June 2004
Aboba, Simon; PPP EAP TLS Authentication Protocol, IETF RFC 2716, October 1999.
Dierks, Allen; The TLS Protocol Version 1.0, IETF RFC 2246, January 1999.

Referring now to FIG. 2, this drawing shows the elements of FIG. 1 together with further elements implementing the invention. Parts mentioned earlier are like-referenced. As indicated by zig-zag wireless transmission/reception paths 10 and 12, classified and unclassified laptops WLT1 and WLT2 are wireless-linked to a network access point AP, this being a processing device of a kind which is available on a “commercial-off-the-shelf” (COTS) basis. In practice there is normally more than one access point AP, but only one is shown to simplify the drawing. The wireless-linked classified laptop WLT1 (but not the unclassified laptop WLT2) runs certificate-based VPN software as described earlier for the wire-linked classified laptop LT1. Both wireless-linked laptops WLT1 and WLT2 communicate with the access point AP using IEEE 802.11. A RADIUS server RS and a certificate server CS are used to authenticate the wireless-linked laptops WLT1 and WLT2 using the access point AP to control access to the wired infrastructure beyond it. The access point AP is connected to the first firewall F1 via a TEMPEST barrier B and a protocol layer 3 switch L3S: here “3” indicates a third layer protocol in an ISO seven layer protocol stack. The TEMPEST barrier B is of known kind: it lets through digital signals passing to and from the access point AP, but provides a barrier to analogue signals. The RADIUS server RS, certificate server CS, access point AP, first firewall F1, TEMPEST barrier B and layer 3 switch L3S are connected together by wired connections 14 defining a physical LAN.

The certificate server CS creates certificates for and issues them to users. It also keeps a store of the certificates issued and updates certificate revocation lists for users whose access has become revoked. It copies valid certificates and notifies revoked certificates to the RADIUS server RS, which carries out authentication. A user certificate generated originally by the certificate server CS is validated every time the associated user wirelessly connects, against credentials stored at any convenient point (in this case the RADIUS server RS).

In order to communicate with the classified WAN N1 via the first firewall F1, a user of the wireless-linked classified laptop WLT1 firstly initiates a mutual authentication process with the access point AP using a published authentication technique such as EAP-TLS previously referenced: i.e. the wireless-linked classified laptop WLT1 and the RADIUS server RS authenticate one another. This process is an exchange which is encapsulated in the IEEE 802.1x protocol, and it is implemented over the wireless link 10 between the classified laptop WLT1 and the access point AP. The access point AP translates the IEEE 802.1x exchange into a RADIUS exchange which is conveyed via the first firewall F1 to the RADIUS server RS for validation. If the user of the wireless-linked classified laptop WLT1 is authenticated by virtue, of presenting a valid certificate, wireless encryption keys K1 derived from the authentication technique (EAP-TLS) are set up in the access point AP and the wireless-linked classified laptop WLT1. The encryption keys K1 are used to encrypt and decrypt messages as they are transmitted and received over the wireless link 10.

Using this now secured wireless link 10, the wireless-linked classified laptop WLT1 requests a VPN “tunnel” as described earlier for the wire-linked classified laptop LT1, from the second firewall F2. This process results in two layers of security from the wireless-linked classified laptop, one of which is removed by the access point AP, and the other of which is removed by the second firewall F2.

The foregoing wireless security technique described with reference to FIG. 2 gives a degree of protection which will be acceptable for many purposes, but it cannot be used in many scenarios due to the limitations described earlier. It is not practical to submit an implementation of an authentication technique such as EAP-TLS for approval because it is likely to change, and as has been said a changed version is no longer approved. Moreover the approval process is costly.

It is an important step towards having a demonstrably secure system by protecting wireless access to the classified WAN N1 using the same VPN certification process that is used to protect wired dial-up access from laptop LT1 via PSTN N3. However, the VPN certification process assumes that an attacker needs physical access to a communications path in order to intercept communications upon it, and that the attacker's physical presence makes it liable to be identified. That is a reasonable assumption for a wired communications link but less so for a wireless link: a wireless link can be tapped into or altered without an attacker's physical presence, so a VPN certification process used with a wireless link does not provide protection sufficient for CESG approval.

A further problem is that the RADIUS server RS and the certificate server CS are computer-based products which are vulnerable to attack. The RADIUS and certificate management functionality, the access point AP and the computer hosting the RADIUS Server RS and the certificate server CS cannot be trusted to defend themselves against any serious attack without additional functionality. If the requirement is for a higher level of security, these items should collectively have security equivalent to that of the PSTN N3 and links T1 and T3.

In many scenarios, to achieve a higher level of security, it is for example desirable to guard against an attacker stealing an unclassified laptop WLT2 and using its certificate to attack the configuration of the access point AP so that a certificate is not needed for wireless access. Other possible attacks are to attack the layer 3 switch configuration, or the certificate server CS to insert rogue certificates, or the RADIUS server RS to give an unauthorised instruction to the access point AP to grant permission to pass an undesirable message or messages.

The solution to this higher level security problem is to subdivide into logical LANs the physical LAN consisting of the access point AP, the first firewall F1, the TEMPEST barrier B, the layer 3 switch L3S, the RADIUS server RS, the Certificate server CS and their wired connections 14: this physical LAN together with the first firewall F1 defines a receiving network RN. Logical LANs are two or more LANs using the same physical wired links but with communications separated by encryption, data tagging or trusted hardware. The logical LANs are implemented as follows: a first logical LAN, referred to as the management LAN, includes and manages the following elements: the layer 3 switch L3S, the access point AP, the RADIUS server RS and the Certificate server CS. The management LAN treats the first firewall F1 as untrusted because it is connected to the Ethernet LAN E1, which is unclassified and therefore more at risk of coming under hostile attack. The first firewall F1 is therefore not allowed to participate in management of any element of the management LAN, and merely monitors data flow. For this reason it is not treated as part of the management LAN, even though it provides data flow paths for certificate authentication and communication with the Ethernet LAN E1.

The access point AP is configured so that it cannot be remotely managed except by items that are on the management LAN. The layer 3 switch L3S is trusted to enforce a rule that message traffic from ports on the management LAN can only go to other ports on the management LAN. In addition, the access point AP and layer 3 switch L3S are configured so that all their remote management has to be done via SSH. The management LAN is also configured to permit the access point AP to contact RADIUS server RS to make authentication requests on behalf of a user of either of the wireless-linked laptops WLT1 and WLT2.

The first firewall F1 is configured to enforce a rule that the only traffic allowed to reach the access point AP is SSH traffic from the RADIUS server RS, NTP packets and RADIUS traffic. The layer 3 switch L3S is configured so that it cannot be remotely managed except by the RADIUS server. The first firewall F1 and layer 3 switch L3S are further configured so that all items on the management LAN synchronize their time to the NTP server and all NTP packets arriving from elsewhere are discarded.

A second logical LAN (communications LAN) is defined which allows the wireless-linked laptops WLT1 and WLT2 to communicate via the first firewall F1 with the Ethernet LAN E1 and then onwards either with the classified WAN N1 or with the unclassified WAN N2. The first firewall F1 is configured so that message traffic to and from the wireless-linked laptops WLT1 and WLT2 cannot go to either the RADIUS server RS or the Certificate server CS, thereby protecting these servers from attack via the wireless network defined by wireless links 10 and 12 or via an Unclassified network defined by the Ethernet LAN E1: computers connected to these networks could potentially be used by Trojan horse or other attacker software to breach the security of the wireless system defined by the physical network WN consisting of the access point AP, the first firewall F1, the TEMPEST barrier B, the layer 3 switch L3S, the RADIUS server RS, the Certificate server CS and their wired connections 14, and the networks E1, N1, N2, DMZ Z1 and firewalls F2 to F4 connected to it. However, with these two logical LANs, a hostile wireless-linked laptop has no path to the RADIUS server RS unless it achieves access to the wired links 14, in which case it could simulate being on either of the logical LANS. It is therefore important for the logical LANs to be kept separate and for the wired links 14 to be protected from unauthorised access.

As an alternative to the use of the RADIUS server RS and Certificate server CS in user authentication, a pre-shared key (PSK) could be used. PSK involves a cryptographic key being shared between a user and an access point AP before being used. The sharing is by some physical action such as a user manually entering it at an access point AP; i.e. the key is not transmitted over a communications link (wired or wireless) to avoid it becoming accessible to an attacker. It has the disadvantage that every access point (when there is more than one) is required the key input to it: use of the RADIUS server RS merely requires a single certificate to be entered on to each wireless-linked laptop WLT1 or WLT2, the certificate having been issued by the Certificate server CS. As a further alternative to using the certificate-based authentication technique described earlier (EAP-TLS), a number of other techniques may be employed. These rely on the user presenting a username and password, or other credentials that the user holds and has shared with the RADIUS server RS, instead of a certificate. Examples of this type of authentication are: EAP-TTLS, PEAP and LEAP which are standards similar to EAP-TLS.

Use of either of the RADIUS and PSK authentication techniques provides security protection for wireless access that is more secure than wired access, because for example:
a) wireless messages are encrypted to a good commercial level, unlike messages sent by wire from the unclassified laptop LT2 which are unencrypted; and
b) interception is only likely within a distance of a relatively few kilometres, whereas with wired connection interception is possible by tapping into a telephone company's wired system at any point traversed by a message.

In the example of the invention described with reference to FIG. 2, a certificate-based VPN product approved by CESG for remote wired access is configured to tunnel through a secure wireless link as if it were tunnelling through a wired connection. The security of wireless access is more secure than that considered by CESG when approving remote wired access. Consequently, it is reasonable for an accreditor to treat the combination of VPN and wireless access as if it was explicitly CESG approved: here an accreditor, is a person or organisation (e.g. a government department) judging fitness of a communications system for secure communications purposes.

Different VPN techniques offer differing types of security to the traffic they carry. In the foregoing embodiment of the invention the Check Point VPN is used to provide integrity and confidentiality by applying authentication and encryption. However, such a VPN technology could be used to provide integrity only through only using authentication and not encryption. It is also possible but unlikely that encryption without authentication may be performed. In a similar fashion the wireless technique used to secure the wireless link (in the above embodiment RADIUS-based or PSK-based) could also provide either authentication or encryption or both.

These options give rise to a number of combinations, the most logical of which are:
a). VPN authentication and encryption, wireless technique authentication and encryption
b) VPN authentication only, wireless technique authentication and encryption and
c) VPN authentication and encryption, wireless technique authentication only.

The invention makes it possible to design a secure communications system for passing government classified information over wireless networks without input from a relevant national technical authority. Security that is as least as good as that obtainable with a wired communications system is obtained using WPA with:
a) a pre-shared key;
b) public key certificates (i.e. the use of EAP-TLS);
c) Any other RADIUS-based authentication mechanism, e.g. EAP-TTLS, LEAP or PEAP.

In addition to wireless systems implementing IEEE 802.11, the invention is applicable to any non-wired communication system, e.g.:
a) wireless carrier systems such as 1) GPRS, 2) third generation mobile phones 3) Bluetooth™, 4) Infra-red; and
b) any satellite or wireless carrier systems that provides suitable encryption.

As an alternative to the use of WPA for providing wireless protection, WPA2 (second generation WPA) could also be used as providing a stronger commercial level of encryption than WPA.

The invention is particularly advantageous for organisations that already have accredited or approved secure wired access techniques, for those techniques may also be used in a wireless scenario. Such an organisation does not have to develop new techniques or retrain its staff: it can continue to use existing infrastructure.

Message transfer as described above has been largely confined to that in one direction. However, in practice message transfer is bidirectional, and messages are sent both from the wireless-linked classified laptop WLT1 to the access point AP and from the access point to ink classified laptop.

The embodiment of the invention described above relates to a method of applying two independent security techniques to achieve a greater level of security across a wireless communications link: one of these security techniques originates from a VPN technology not originally designed for dedicated use on wireless links, and the other technique is designed specifically for use with a wireless communications medium linking the wireless-linked classified laptop WLT1 to the access point AP.

Referring now to FIG. 3, a further embodiment 30 of the invention is shown for use in connection with a prior art wired network employing virtual WANs (as opposed to actual WANs N1 and N2), although these could instead be LANs. The prior art network is indicated by a box 32, and is shown together with modifications to implement the invention. Items wholly within the box 32 are part of the prior art network, and items wholly outside it are not. Items 34 to 38 straddling an upper boundary 32a of the box 32 may be part of (i.e. wire linked to) the prior art network or not depending on mode of operation. In the drawing, subdivided rectangular boxes such as 34 indicate software applications running on remote computers (not shown) communicating (or attempting to communicate) with the prior art network 32.

The box 34 has a classified client software application (e.g. word processing, email) indicated by “C client” to the left of which there are successively VPN FW and 802.11+802.1x sub-boxes, and to the right an 802.1x sub-box. The VPN FW, and 802.11+802.1x and 802.1x sub-boxes have respective input/output (I/O) links 34a, 34b and 34c: of these, link 34a is a wireless link to a wireless access point AP2; link 34b is a dial up wired telephone link to a firewall F7 in the prior art network 32; and link 34c is a wired link to the prior art network 32.

The box 36 is associated with an unauthorised client software application but has no VPN FW, 802.11 or 802.1x sub-boxes. It has an I/O link 36a which is a wired link to the prior art network 32. Even if the user of unauthorised box 36 were to add VPN FW, 802.11 or 802.1x sub-boxes, they would not be recognised by the prior art system because they would lack the necessary certificates that authorise access.

The box 38 has an unclassified client software application indicated by “U client”: to the left of U client there is an 802.11+802.1x sub-box, and to the right an 802.1x sub-box. The 802.11+802.1x and 802.1x sub-boxes have respective I/O links 38a and 38b: of these, link 38a is a wireless link to the access point AP2, and link 38b is a wired link to the prior art network 32.

A further box 40 outside the prior art network 32 is associated with an external “Other” client. It has an 802.11 Wired Equivalent Privacy (WEP) or other WEP sub-box with an I/O link 40a, which is a wireless link to the access point AP2.

The prior art network 32 incorporates a first element 50 referred to as an SMVI, which implements a switch, management of virtual WANs (VWAN) and Internet Authentication Service (IAS) proxy software. The SMVI 50 communicates via respective RADIUS-only firewalls FR1 and FR2 with classified “C” and unclassified “U” RADIUS servers 52C and 52U linked with respective certificate servers “CS” 54C and 54U. The certificate servers 54C and 54U receive their certificates from respective offline certificate servers 56C and 56U, which in turn receive their certificates from a root certificate server 58. Here the expression “offline” means there is no direct electronic or other link: instead transfers are implemented by recording data from one server on to a recording medium such as a compact disc, taking the disc to another server and loading the recorded data into the latter. This gives a high level of security as demonstrably no information flows in the reverse direction.

The SMVI 50 controls access to a single physical connection shown as two virtual connections 60C and 60U. These virtual connections give access to classified and unclassified virtual WANs (VWANs, not shown) in a similar way to that described with reference to FIG. 2. The SMVI 50 authenticates requests for access to the VWANs as described earlier using the RADIUS and certificate servers 52C/54C and 52U/54U, the former for access to the classified VWAN and the latter for access to the unclassified VWAN. Telephone dial-up access to the classified VWAN is available via a firewall F7. The 802.1x software has access to a certificate issued by certificate server 54C or 54U for classified or unclassified access respectively.

In accordance with the invention, the prior art network 32 is modified to replicate items 50 to 54U for use in wireless access. These replicated items are referenced 70 to 74U, and they appear outside the box 32 to indicate they are not part of the prior art network. The access point AP2 communicates via a link 62 with a second SMVI 70, which implements a switch, management of virtual WANs (VWANs) and Internet Authentication Service (IAS) proxy software. The second SMVI 70 communicates via respective RADIUS-only firewalls FR3 and FR4 with classified “C” and unclassified “U” wireless RADIUS servers 72C and 72U linked with respective certificate servers “CS” 74C and 74U. The certificate servers 74C and 74U communicate with respective offline certificate servers 76C and 76U, which in turn communicate offline with the root certificate server 58.

The embodiment 30 operates as follows. At this point, the software applications 34, 36 and 38 are treated as part of the wired prior art network 32 as they make use of wired links 34c, 36a and 38b to communicate with it. The first SMVI 50 communicates with the C client 34 and U client 38 via the 802.1x sub-box (a software application) to the right in each case: this indicates that communications from both of these applications are authenticated; however, the absence of a VPN FW sub-box in each of the message paths from the C client and U client software applications 34 and 38 via links 34c and 38b to the first SMVI 50 indicates that communications from these applications are not VPN encrypted, and so they are only appropriate for directly wired access via paths 34c and 38b. The first SMVI 50 denies all clients access to the classified VWAN virtual connection 60C and to the unclassified VWAN connection 60U until they have been authenticated. The SMVI 50 forwards the authentication of U client 38 to the U RADIUS server 52U via the firewall FR2, which allows only RADIUS traffic to pass through in either direction. If authenticated by the U RADIUS server 52U, U client 38 is allowed access to the unclassified VWAN via virtual connection 60U. Similarly, if authenticated by the C RADIUS server 52C, C client 34 is allowed access to the classified VWAN via virtual connection 60C.

The unauthorised client 36 has no 802.1x sub-box with an appropriate certificate, and so communications from it to the first SMVI 50 via the wired I/O link 36a are not authenticated. Consequently, the first SMVI 50 denies the unauthorised client 36 access both to the classified VWAN and to the unclassified VWAN.

The clients 34 and 38 are now treated as not being part of the prior art network 32. A communication from the C client 34 passes to the access point AP2 from its 802.11+802.1x sub-box (software application). The VPN FW sub-box between the C client 34 and the 802.11+802.1x sub-box indicates that subsequent communications will be VPN encrypted. Via the link 62, the communication passes for authentication to the second SMVI 70, which initiates authentication using the classified wireless C RADIUS server 72C and certificate server 74C via the RADIUS-only firewall FR3. If authenticated by the server 72C, the C client 34 is allowed access to the firewall F7, which checks its, VPN credentials and if appropriate allows it access to the classified VWAN via virtual connection 60C.

The C client 34 can also communicate with the firewall F7 by dial-up telephone access using its I/O link 34b, to which a communication passes via its VPN FW sub-box only, indicating that such a communication is VPN encrypted but not otherwise authenticated. The firewall F7 checks the communication's VPN credentials and if appropriate allows it access to the classified VWAN.

Communications from the U Client 38 pass via its 802.11+802.1x sub-box to the access point AP2 indicating that such communications are authenticated but not VPN encrypted. Via an analogous authentication route using firewall FR4, unclassified U RADIUS and certificate servers 72U and 74U, it is authenticated and given access to the unclassified VWAN 60U.

Communications from the Other client 40 pass to the access point AP2 via an 802.11 sub-box only. They do not have 802.1x authentication. They have WEP encryption, to which the access point AP2 has a key. The access point AP2 notes the absence of 802.1x authentication in these communications, and instructs the SMVI 70 to pass them only towards firewall F8 and thence to the Internet. One use of such technology would be to permit laptop computers owned by a different organisation to the one owning the infrastructure depicted in FIG. 3 to have access to the Internet without requiring an authentication certificate to be issued. WEP security may be considered to suffice to prevent Internet access by unidentified individuals, whilst being insufficient to protect infrastructure depicted in FIG. 3. This embodiment of the invention therefore permits trusted computers to have access to an internal email network (intranet) of an organisation owning such infrastructure, protected in part by 802.1x software, and a visitor's computer to have access to the Internet only, with the visitor's computer using a wireless path protected by WEP. WEP is not the only method that could be used to protect the “Other” client. WPA PSK, or another wireless authentication method based on a shared secret or a username/password combination could be used.

Referring now to FIG. 4, a modified version 30a of the embodiment 30 of the invention is shown, and parts equivalent to those described earlier are like-referenced. Here the relevant modification is that wireless network offline certificate servers 76C and 76U have been removed and certificate servers 74C and 74U obtain their certificates from the wired network's offline certificate servers 56C and 56U respectively. This is beneficial because it reduces costs. The modified version 30a is otherwise equivalent to the embodiment 30 described with reference to FIG. 3 and will not be described further.

FIG. 5 shows a further modification, i.e. a modified version 30b of the embodiment 30a, and parts equivalent to those described earlier are again like-referenced. Here the modification is that the second SMVI 70 dispenses with its hitherto associated unclassified certification items, i.e. unclassified RADIUS and certificate servers 72U and 74U. Instead, the second SMVI 70 and its RADIUS-only firewall FR4 is connected by a link 78 to the wired network's unclassified RADIUS server 52U, which makes use of certificate and offline certificate servers 54U and 56U. This avoids duplication of unclassified certification items. The modified version 30b is otherwise equivalent to the embodiment 30a described with reference to FIG. 4 and will not be described further.

FIG. 6 shows another modification, i.e. a modified version 30c of the embodiment 30b, and parts equivalent to those described earlier are again like-referenced. Here the modification is that the second SMVI 70 dispenses with its hitherto associated classified certification items, i.e. firewall FR3 and classified RADIUS and certificate servers 72C and 74C. Instead, the embodiment 30c makes use of the fact that certificates issued from the unclassified certificate server 54U can be marked as either wireless or wired. The certificate server 54U can therefore issue a certificate to C client 34 marked “wireless only”. Hence when C client 34 authenticates using the 802.11+802.1x sub-box and the wireless certificate from certificate server 54U via link 34a, the combination of the access point AP2 and the second SMVI 70 will correctly authenticate the certificate and allow communications with the firewall F7 and the unclassified VWAN connection 60U. All further communications will be between C client 34 VPN FW sub-box and firewall F7. However, if the C client 34 were to present the same certificate to the first SMVI 50 in the prior art network 32 using the link 34c, access to the unclassified VWAN connection 60U will be disallowed due to the certificate being marked wireless only, because the link 34c is wired. Should the C client 34 present a certificate marked “wired” and issued from the classified certificate server 54C over the link 34c, SMVI 50 will correctly allow access to the classified VWAN connection 60C.

It is possible to provide a further degree of protection for computer-based communications in accordance with the invention. A laptop may be stolen while it is in use, e.g. while its user is temporarily absent from his or her workstation. A laptop containing stored certificates may be stolen after its user has entered a cryptographic key to access the laptop's hard disk. In such circumstances, encryption of the hard disk and other well-known protective techniques will fail to provide security for the laptop's contents. However, the security threat posed by laptop theft may be counteracted by techniques known for other purposes: i.e. programming techniques and software are known which are designed to screen lock a computer when the computer's authorised user leaves it unattended, e.g. Radio-Frequency Identification (RFID) tags. Such techniques may also be adopted to provide security for the contents of a stolen laptop, certificates stored on the laptop's hard disk in particular.

It is a straightforward matter presenting no difficulty to those of ordinary skill in the art of computerised communications to produce appropriate computer software for implementing the computer-based communications system embodiments described herein. Such software may be recorded on carrier media for running on a conventional computerised communications network. It may be implemented without requiring invention, because individual procedures described above are well known. Such software and communications system will therefore not be described further.

1. A method for computer communications having the steps of:
a) establishing a wireless link between computer apparatus and a receiving network implementing two protocols at least one of which is for encrypting messages, one of the two protocols being a virtual private network (VPN) protocol suitable for securing wire-linked communications and the other of the other two protocols being a wireless-linking protocol of a kind suitable for securing wireless-linked communications;
b) applying both protocols to a message to render it doubly secured;
c) sending the doubly secured message over the wireless link; and
d) processing the doubly secured message to recover the message.

2. A method according to claim 1 wherein step b) of applying both protocols comprises applying the VPN protocol to a message to render it VPN-secured and applying the wireless-linking protocol to the VPN-secured message to render it doubly secured.

3. A method according to claim 1 wherein the receiving network has a logical LAN configuration protecting it against unauthorised access.

4. A method according to claim 3 wherein:
a) the logical LAN configuration has a first logical LAN and a second logical LANs;
b) the first logical LAN:
i) has elements which cannot be remotely managed except by at least one other element of that LAN,
ii) has ports from which message traffic is constrained to go only to other ports on that LAN, and
iii) implements a wireless authentication process and secure communication within that LAN; and
c) the second logical LAN enables the computer apparatus when authenticated to communicate with a classified network or an unclassified network, and has firewall functionality configured to avoid message traffic to and from the computer apparatus affecting the first logical LAN.

5. A method according to claim 4 wherein the first logical LAN includes:
a) an access point for communication with wireless-linked computer apparatus;
b) a switch to constrain message traffic from first logical LAN ports to go only to other first logical LAN ports; and
c) a RADIUS server for implementation of the wireless-linking protocol which provides an authentication process.

6. A method according to claim 5 wherein the first logical LAN is associated with firewall functionality configured to monitor data flow within and to and from that LAN but excluded from management of elements of that LAN.

7. A method according to claim 1 wherein the wireless-linking protocol involves certificate-based authentication and is implemented by means of a RADIUS server.

8. A method according to claim 1 wherein the wireless-linking protocol is implemented by means of a pre-shared key (PSK).

9. A method according to claim 1 wherein the wireless-linking protocol involves authentication by EAP-TLS, EAP-TTLS, PEAP or LEAP as herein defined.

10. A method according to claim 1 wherein step b) of applying both protocols involves producing secured status by encryption to produce a VPN-encrypted message and to provide for the doubly secured message to be doubly encrypted, and step d) of processing the doubly secured message to recover the message involves double decryption.

11. A method according to claim 1 wherein the receiving network has classified and unclassified virtual networks, and the method includes allowing the doubly secured message access to the classified virtual network and also allowing wireless messages access to the unclassified virtual network if such messages are secured by the wireless-linking protocol but not the VPN Protocol.

12. A method according to claim 11 wherein the receiving network is associated with offline and root certificate servers and the method includes authenticating wireless messages using certificates from such servers.

13. A method according to claim 11 wherein the receiving network has an unclassified RADIUS server and the method includes authenticating wireless messages using certificates from that server.

14. A method according to claim 11 wherein the receiving network has an unclassified certificate server arranged to supply certificates marked to indicate use by wireless only and the method includes authenticating messages by wireless using certificates so marked from that server.

15. A method according to claim 1 including the step of counteracting a security threat posed by potential computer theft by arranging for the computer apparatus to be screen locked when it becomes unattended by authorised personnel.

16. Apparatus for computer communications incorporating:
a) wireless linking apparatus for establishing a wireless link between computer apparatus and a receiving network implementing two protocols at least one of which is for encrypting messages, one of the two protocols being a VPN protocol suitable for securing wire-linked communications and the other of the two protocols being a wireless-linking protocol of a kind suitable for securing wireless-linked communications;
b) means for applying both protocols to a message to render it doubly secured;
c) means for sending the doubly secured message over the wireless link; and
d) means for processing the doubly secured message to recover the message.

17. Apparatus according to claim 16 wherein the means for applying both protocols is arranged to apply the VPN protocol to a message to render it VPN-secured and to apply the wireless-linking protocol to the VPN-secured message to render it doubly secured.

18. Apparatus according to claim 16 wherein the receiving network has a logical LAN configuration protecting it against unauthorised access.

19. Apparatus according to claim 18 wherein:
a) the logical LAN configuration has a first logical LAN and a second logical LAN;
b) the first logical LAN:
i) has elements which cannot be remotely managed except by at least one other element of that LAN,
ii) has ports from which message traffic is constrained to go only to other ports on that LAN, and
iii) implements a wireless authentication process and secure communication within that LAN; and
c) the second logical LAN enables the computer apparatus when authenticated to communicate with a classified network or an unclassified network, and has firewall functionality configured to avoid message traffic to and from the computer apparatus affecting the first logical LAN.

20. Apparatus according to claim 19 wherein the first logical LAN includes:
a) an access point for communication with wireless-linked computer apparatus;
b) a switch to constrain message traffic from first logical LAN ports to go only to other first logical LAN ports; and
c) a RADIUS server for implementation of the wireless-linking protocol which provides an authentication process.

21. Apparatus according to claim 20 wherein the first logical LAN is associated with firewall functionality configured to monitor data flow within and to and from that LAN but excluded from management of elements of that LAN.

22. Apparatus according to claim 16 including a RADIUS server arranged to implement the wireless-linking protocol, the wireless-linking protocol involving certificate-based authentication.

23. Apparatus according to claim 16 including means for implementing a pre-shared key (PSK) to provide the wireless-linking protocol.

24. Apparatus according to claim 16 including means for implementing authentication by EAP-TLS, EAP-TTLS, PEAP or LEAP to provide the wireless-linking protocol.

25. Apparatus according to claim 16 wherein the means for applying both protocols is arranged to provide a VPN-encrypted message and to provide for the doubly secured message to be doubly encrypted, and the means for processing the doubly secured message to recover the message is arranged to provide double decryption.

26. Apparatus according to claim 16 wherein the receiving network has classified and unclassified virtual networks, and the apparatus is arranged to allow the doubly secured message access to the classified virtual network and also to allow wireless messages access to the unclassified virtual network if such messages are secured by the wireless-linking protocol but not the VPN protocol.

27. Apparatus according to claim 26 wherein the receiving network is associated with offline and root certificate servers and the apparatus is arranged to authenticate wireless messages using certificates from such servers.

28. Apparatus according to claim 26 wherein the receiving network has an unclassified RADIUS server and provides for the apparatus to authenticate wireless messages using certificates from that server.

29. Apparatus according to claim 26 wherein the receiving network has an unclassified certificate server for supplying certificates marked to indicate use by wireless only providing for the apparatus to authenticate messages by wireless using certificates so marked from that server.

30. Apparatus according to claim 16 for counteracting a security threat posed by potential computer theft by providing for the computer apparatus to become screen locked when unattended by authorised personnel.

31. A computer program product for computer communications and comprising a computer-readable medium embodying program code instructions for execution by a computer processor wherein the instructions are for controlling a computerised communications network to execute the steps of:
a) establishing a wireless link between computer apparatus and a receiving network implementing two protocols at least one of which is for encrypting messages, one of the two protocols being a VPN protocol suitable for securing wire-linked communications and the other of the two protocols being a wireless-linking protocol of a kind suitable for securing wireless-linked communications;
b) applying both protocols to a message to render it doubly secured;
c) sending the doubly secured message over the wireless link; and
d) processing the doubly secured message to recover the message.

32. A computer program product according to claim 31 wherein the instructions are also for implementing application of both protocols by applying the VPN protocol to a message to render it VPN-secured and applying the wireless-linking protocol to the VPN-secured message to render it doubly secured.

33. A computer program product according to claim 31 wherein the instructions are also for implementing a logical LAN configuration protecting the receiving network against unauthorised access.

34. A computer program product according to claim 33 wherein:
a) the logical LAN configuration has first and second logical LANs;
b) the first logical LAN:
i) has elements which cannot be remotely managed except by at least one other element of that LAN,
ii) has ports from which message traffic is constrained to go only to other ports on that LAN, and
iii) implements a wireless authentication process and secure communication within that LAN; and
c) the second logical LAN enables the computer apparatus when authenticated to communicate with a classified network or an unclassified network, and has firewall functionality configured to avoid message traffic to and from the computer apparatus affecting the first logical LAN.

35. A computer program product according to claim 34 wherein the first logical LAN includes:
a) an access point for communication with wireless-linked computer apparatus;
b) a switch to constrain message traffic from first logical LAN ports to go only to other first logical LAN ports; and
c) a RADIUS server for implementation of the wireless-linking protocol which provides an authentication process.

36. A computer program product according to claim 35 wherein the first logical LAN is associated with firewall functionality configured to monitor data flow within and to and from that LAN but excluded from management of elements of that LAN.

37. A computer program product according to claim 34 wherein the instructions are also for implementing the wireless-linking protocol by certificate-based authentication using a RADIUS server.

38. A computer program product according to claim 34 wherein the instructions are also for implementing the wireless-linking protocol by means of a pre-shared key (PSK)

39. A computer program product according to claim 34 wherein the instructions are also for implementing the wireless-linking protocol by means of authentication using EAP-TLS, EAP-TTLS, PEAP or LEAP.

40. A computer program product according to claim 34 wherein the instructions are also for implementing:
a) application of both protocols by encryption to provide a VPN-encrypted message and to provide for the doubly secured message to be doubly encrypted, and
b) processing of the doubly secured message to recover it by double decryption.

41. A computer program product according to claim 34 wherein the receiving network has a classified virtual network, and an unclassified virtual network, and the instructions are also for implementing access of the doubly secured message to the classified virtual network and also access of wireless messages to the unclassified virtual network if such messages are secured by the wireless-linking protocol but not the VPN protocol.

42. A computer program product according to claim 41 wherein the receiving network is associated with offline and root certificate servers and the instructions are also for authenticating wireless messages using certificates from such servers.

43. A computer program product according to claim 41 wherein the receiving network has an unclassified RADIUS server and the instructions are also for authenticating wireless messages using certificates from that server.

44. A computer program product according to claim 41 wherein the receiving network has an unclassified certificate server arranged to supply certificates marked to indicate use by wireless only and instructions are also for wireless authentication using certificates so marked from that server.

45. A computer program product according to claim 31 wherein the instructions are also for counteracting a security threat posed by potential computer theft by providing for the computer apparatus to be screen locked when it becomes unattended by authorised personnel.
